(19) United States
(12) Patent Application Publication
(10) Pub. No.: US 2006/0053061 A1
(43) Pub. Date: Mar. 9, 2006

(54) Systems and methods for processing group orders

(76) Inventor: Gregory R. Evans, Royal Oak, MI (US)

Correspondence Address: HONIGMAN MILLER SCHWARTZ & COHN LLP, 38500 WOODWARD AVENUE, SUITE 100, BLOOMFIELD HILLS, MI, 48304-5048, US

(21) Appl. No.: 10/937,679

(22) Filed: Sep. 9, 2004

(51) Int. Cl. G06Q 30/00

(52) U.S. Cl. 705/15; 705/1

(57) ABSTRACT

Systems and methods for coordinating and scheduling interactions based at least in part on the group affiliations of the invitees. Vendor and group selections are made in the process of defining the interaction. Invitations are sent to invitees associated with the selected group. Responses generated by the invitees can include one or more selections from a predefined list of options provided in the invitation.

### BACKGROUND OF THE INVENTION

The invention relates generally to systems and methods for processing group orders (collectively the “system”). More specifically, the system relates to processing group orders in which individual choices are accommodated in the context of the group order.

It is often difficult to accommodate the individual preferences of a participant or invitee in the context of an interaction involving a group of participants. Whether the group interaction involves lunch at a restaurant, taking a cruise, purchasing theater tickets, ordering in food for a business meeting, or other types of activities requiring the submission of a group order or reservation (collectively “interactions”), there are often significant scheduling, coordination, and other administrative challenges that must be overcome. Existing applications do not provide the ability of individual participants to easily submit individualized orders in the context of a group affiliation that incorporates attributes defined by the group.

One common category of group interactions relates to the ordering of food for a group of participants. Many social gatherings and business meetings involve the element of food. Whether the purpose of a particular interaction is personal, business, or some combination of both, the scheduling and coordination activities necessary to organize interactions can involve a significant investment of time and effort by the individual(s) involved. This is true whether or not the participants to the interaction are meeting at a restaurant, or whether the food is delivered to a location not affiliated with the food vendor.

The schedules for many participants are often highly contingent on outside factors not relating to the interaction itself. Thus, it is not uncommon for potential participants who initially commit to a particular interaction to ultimately “back out” of the interaction. Similarly, it is not unusual for someone to commit to an interaction in the last minute after an initially negative response.

Further complicating the scheduling and coordination process is the desire to accommodate the individual menu selections of the various participants without placing an undue burden on the coordinator of the interaction. The existing art does not appear to provide an automated mechanism that supports the coordination of common or group-based aspects of the interaction (e.g. the date, time, location, etc.) while simultaneously supporting the ability of individual participants to make their own menu selections. Existing applications do not appear to support the ability of individual participants to submit orders in the context of a group affiliation. Existing applications typically require the coordinator of the interaction to follow-up individually with each invitee.

The existing art affirmatively teaches away from such a group processing capability and the ability to follow-up with individual invitees in an automated manner. Historical restaurant and food service practices have relied exclusively on either the group-based attributes of the order (e.g. the aggregate order from a single point of contact), or the individual-based attributes of the order (e.g. the individual menu selections of a group of people at a restaurant). There is no suggestion in the art to accommodate individual-based attributes in the context of a group interaction with influence being given to both individual based attributes and group-based attributes in an online system for processing group orders. For example, there is no suggestion in the art to automatically accommodate the menu selections of each invitee. The dichotomy and historical divergence of existing practices affirmatively teaches away from such an approach. Moreover, there is no economic incentive for an individual vendor to create and manage the infrastructure for such an approach. Lastly, there does not appear to be a business model in the existing art poised to build much less exploit an infrastructure suited for the submission of orders to multiple entities in direct competition with each other.

### SUMMARY OF THE INVENTION

The present invention includes a variety of systems and methods (collectively the “system”) that accommodate individual-based participant selections in the context of a group interaction that is constrained by group-based attributes.

An interaction involving one or more groups can be created using the system. Invitations for interactions (“invitations”) can be sent to invitees associated with the one or more of the groups that have been identified for inclusion in the interaction by the coordinator for the interaction. The response of invitees to the invitation can include a selection of one or more predefined options set forth in the invitation. The system can support the creation, modification, and deletion of predefined invitation templates, groups (including membership lists), and invitee addresses. Coordinator profiles, group profiles, and invitee profiles can automatically influence the processing performed by the system. Profiles can be influenced by the history of various groups, coordinators, and invitees with respect to the system.

In some embodiments of the system, the system is operated and maintained by an Application Service Provider (“ASP”). Different vendors may pay the ASP various fees in order to be included as a possible destination for an interaction processed by the system.

In some embodiments of the system, a coordinator interface can be used to create, modify, and delete group-level and interaction-level information, while various invitee interfaces can be used to create, modify, and delete invitee-level information.

An order or interaction subsystem can be used to process all information relating to the orders processed by the system. A group or member subsystem can be used to process all information relating to groups, and the invitees belonging to those groups.

The present invention will be more fully understood upon reading the following detailed description in conjunction with the accompanying drawings.

### BRIEF DESCRIPTION OF THE DRAWINGS

FIG. 1 is a block diagram illustrating examples of the some of the elements that can be included in a group ordering system.

FIG. 2 is a data diagram illustrating examples of elements that can influence an interaction processed by the system.

FIG. 3 is a data diagram illustrating examples of elements that can influence an order generated by the system.

FIG. 4 is a flow chart diagram illustrating an example of a process flow from the perspective of a coordinator.

FIG. 5 is a flow chart diagram illustrating an example of a process flow from the perspective of a vendor.

FIG. 6 is a flow chart diagram illustrating an example of a process flow from the perspective of an invitee.

FIG. 7 is a flow chart diagram illustrating an example of a process flow from the perspective of an Application Service Provider (“ASP”).

FIG. 8 is a flow chart diagram illustrating an example of a process flow from the perspective of the overall system.

FIG. 9 is a detailed flow chart diagram illustrating a second example of a process flow from the perspective of the overall system.

FIG. 10 is a detailed flow chart diagram illustrating a process flow from the perspective of the overall system in the context where the vendor is a restaurant.

FIG. 11 is a block diagram illustrating an example of a subsystem-level view of the system.

FIG. 12 is a block diagram illustrating a second example of a subsystem-level view of the system.

FIG. 13 is a screen print illustrating an example of a group ordering system where the vendors are in the restaurant and catering industry.

FIG. 14 is a screen print illustrating an example of a restaurant search.

FIG. 15 is a screen print illustrating an example of a search result generated by the system.

FIG. 16 is a screen print illustrating an example of an invitee/group screen in a coordinator interface.

FIG. 17 is a screen print illustrating an example of a group setup screen in a coordinator interface.

FIG. 18 is a screen print illustrating an example of a group maintenance screen in a coordinator interface.

FIG. 19 is a screen print illustrating a second example of a group maintenance screen in a coordinator interface.

FIG. 20 is a screen print illustrating an example of an address capture mechanism that can be invoked through the coordinator interface.

FIG. 21 is a screen print illustrating an example of a delivery method selection screen in a coordinator interface.

FIG. 22 is a screen print illustrating an example of an order scheduling screen in a coordinator interface.

FIG. 23 is a screen print illustrating an example of a select payment screen in a coordinator interface.

FIG. 24 is a screen print illustrating an example of a send invitation screen in a coordinator interface.

FIG. 25 is a screen print illustrating an example of an invitation preview screen in a coordinator interface.

FIG. 26 is a screen print illustrating an example of an order confirmation screen in a coordinator interface.

### DETAILED DESCRIPTION

I. Overview and Introduction of Elements

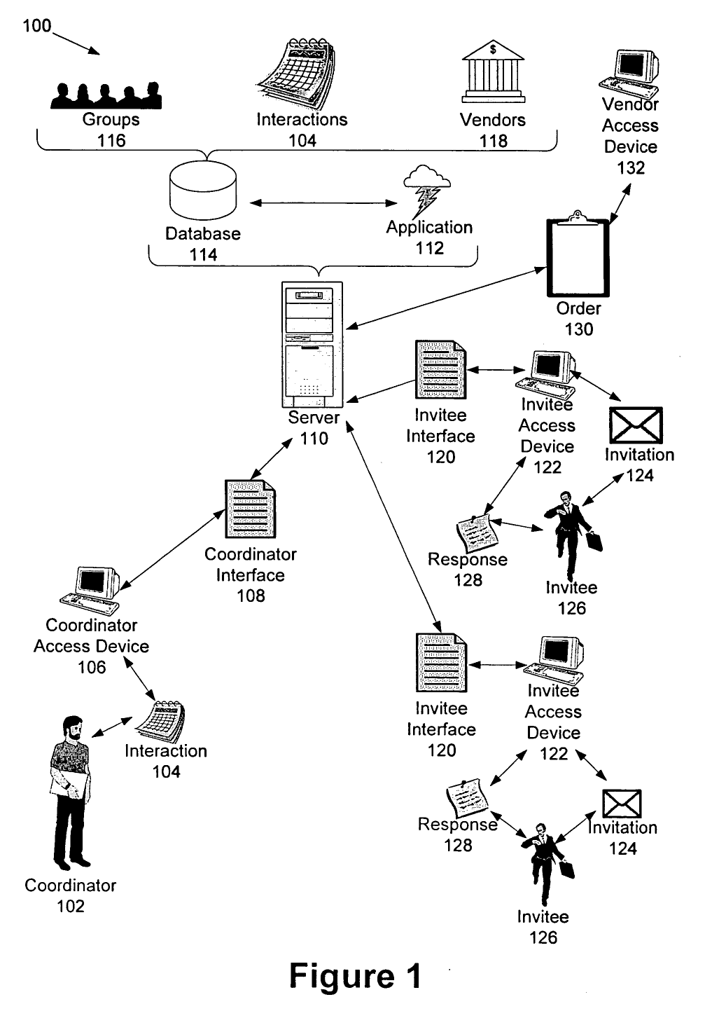

FIG. 1 is a block diagram illustrating an example of the some of the elements that can be included in a group ordering system or method (collectively the “system”) 100.

A. Coordinator

A coordinator 102 is typically a human being responsible for organizing an interaction 104 with a group 116 of people. Coordinators 102 can also be referred to as organizers, schedulers, or administrators. In some embodiments, the coordinator could be some form of an automated computer device, such as a neural network, an artificial intelligence component, an expert system, a project scheduling application, or some other form of automated processing. The system 100 can accommodate many coordinators 102. In some instances, the coordinator 102 will also be an invitee 126, while in other instances, the coordinator 102 will not personally attend the interaction 104.

B. Interaction

An interaction 104 can also be referred to as an event, activity, show, outing, or meeting (collectively “interaction” 104). The system 100 can be used to process group orders for a wide variety of different interactions 104. Examples of interactions 104 include but are not limited to: co-workers going out for lunch; a trip to an amusement park; season tickets to the theater; ordering in food for a family celebration; friends taking advantage of an aggregate discount for online purchases of consumer electronics; and cruises that involve a variety of different excursion options. The system 100 is used to schedule and coordinate interactions 104, so the term interaction 104 as used in conjunction with the system 100 typically refers to the planning stage of the excursion. Thus, an interaction 104 could also be referred to as a potential interaction, a planned interaction, or a future interaction.

In the example of a restaurant interaction 104, the interaction 104 submitted to the system 100 will include a vendor 118, a vendor location, a date, a time, and a list of invitees 126 (e.g. one or more groups 116). Information such as the particular menu offerings of the vendor 118 are not included by the coordinator 102 as part of the interaction 104. In a preferred embodiment, the system 100 does not make the coordinator 102 responsible for knowledge about any vendors 118.

Interactions 104 are generated by coordinators 102 accessing the system 100 through a coordinator access device 106.

C. Access Devices

An access device is any device capable of exchanging information with the system 100. Potentially any device capable of exchanging information with another device may be used as an access device with respect to the system 100. Common examples of access devices include but are not limited to: desktop computers; laptop computers; personal digital assistants (“PDAs”); cell phones; land-line phones; voice recognition technology; satellie pagers; hand held wireless devices; mainframe computers; work stations; terminals; and any other device capable of interacting with the system 100. In a preferred embodiment, access devices are capable of connecting with the Internet and World Wide Web. The system 100 can communicate with multiple access devices at the same time. Users of the system 100 are preferably identified by a login ID and password, not the physical device used to interact with the system 100.

In addition to being identified by the type of device serving as access devices for the system 100, access devices can also be categorized on the basis of the person or user of the device. For example, a coordinator access device 106 is any access device used by the coordinator 102 to interact with the system 100. Similarly, an invitee access device 122 is any access device used by an invitee 126 to access the system 100 and a vendor access device 132 is any access device used by a vendor 118 to interact with the system 100. The same physical device can serve as different types of access devices. For example, the coordinator 102 may also be one of the invitees 126 with respect to a particular invitation 124.

D. Interfaces

An interface is the user interface (preferably a graphical user interface such as a web page but virtually any other type of interfaces can be used) provided by the system 100 for interaction with various users of the system 100, such as coordinators 102, invitees 126, and vendors 118. Interfaces are the means by which users interact with an application 112 that provides and supports the functionality of the system 100. The system 100 can communicate through multiple interfaces at the same time.

A coordinator interface 108 is the means by which the coordinator 102 interacts with the application 112. An invitee interface 120 is the means by which invitees 126 can interact with the application 112. A vendor interface is the means by which vendors 118 interact with the application 112.

In some embodiments of the system 100, the same web page can serve as both the coordinator interface 108 and the invitee interface 120 at the same time. In some Application Service Provider (“ASP”) embodiments of the system 100, the vendor 118 does not interact directly with the database 114 and the application 112. Instead, personnel working for the ASP interact with those components on behalf of the vendor 118.

E. Server

In many embodiments of the system 100, a server 110 is used to host a database 114 and the application(s) 112 needed to support the functionality of the system 100. Many different server 110 configurations can be used to support the system 100. In some embodiments, the database 114 and application(s) 112 will reside on different servers.

In a preferred embodiment, the server 110 is supported, operated, and maintained (collectively “controlled”) by an Application Service Provider (“ASP”). This can reassure different vendors 118 that they are being treated fairly. In other embodiments, the server 110 can be controlled by one of the vendors 118 or even one of the coordinators 102. It is possible to implement the system 100 with only one vendor 118 or even with only one coordinator 102. For example, the system 100 could be implemented to facilitate the ordering of lunch in the company cafeteria.

In many embodiments, the server 110 is one or more web servers, with the system 100 being provided to coordinators 102 without any charge, through the use of an Internet connection. In a preferred embodiment, vendors 118 pay for the benefit of being listed on the system 100. Typically, vendors 118 pay a transaction-based fee to the operator of the system 100. A wide variety of different fee and “bid” structures can be used to facilitate competition between vendors 118 within the system 100. For example, the willingness to pay a higher fee may result in a vendor 118 receiving more favorable positioning within a list of vendors 118. The system 100 can flexibly accommodate different business models aimed at fostering competition between vendors 118, and even potentially between coordinators 102.

F. Database

A database 114 is the mechanism by which the system 100 stores information. One or more databases 114 can reside on one or more servers 110. Databases are typically relational databases, although other data storage techniques including object-oriented databases and hierarchical databases can also be used. In some alternative embodiments, data storage techniques such as arrays, pointers, cookies, and flat files can be incorporated into the system 100.

Databases 114 used by the system 100 can potentially store any bit of relevant information relating to a use of the system 100. Examples of important information to be stored in the database 114 include information relating to a group 116, an interaction 104, and a vendor 118. Virtually any bit of information stored in the database 114 can be used to influence how the system 100 processes a particular invitation 124, interaction 104, or order 130. Different embodiments of the system 100 can be configured differently, so that different processing is influenced differently. Even within a single embodiment of the system 100, it is possible for different vendors 118 and different coordinators 102 to customize how the system 100 is influenced by different factors.

1. Groups

A group 116 is any collection of two or more invitees 126 identified as a group 116 by a coordinator 102. In many embodiments, groups 116 are defined exclusively with respect to a particular coordinator 102 (e.g. groups are local groups or private groups). In other instances, it may be desirable for a system 100 to define groups publicly or globally (e.g. groups defined for use by more than one coordinator 102). For example, a group 116 of friends may desire that all members of their group to act as a coordinator 102 with respect to initiating interactions 104. Similarly, in an office environment, it may be desirable for predefined teams of employees to be defined as groups 116 within the system 100. It is possible for membership in a group 116 to be defined in terms of other groups 116. In other words, a group 116 can be a member of another group 116 in certain embodiments. The system 100 can store a hierarchy of groups 116 and relationships relating to the members of those groups 116.

2. Interactions

The purpose of the system 100 is the assist coordinators 102 initiate interactions 104 with one or more groups 116. Potentially all information relevant to the processing of interactions 104 by the system 100 can be stored in the database 114 so that relevant information can be taken into considering by the system 100, and used to influence the processes of proposing interactions 104, creating invitations 124, receiving responses 128, and transmitting orders 130.

3. Vendors

A vendor 118 is typically a business organization, although non-profit organizations, religious organizations, community organizations, and government agencies can also be vendors 118 in certain contexts. Vendors 118 receive orders 130 from coordinators 102 scheduling interactions 104 for groups 116 using the system 100. In some embodiments, there is no direct communication between the vendor 118 and the coordinator 102, with the system 100 automatically interfacing between both parties. Potentially all information relating to vendors 118 that is relevant to the processing of the system 100 can be stored in the database 114.

G. Application

An application 112 typically resides on the server 110. One or more applications 112 support the programming logic of the system 100. Any mechanism capable of supporting the logic of the system 100 can be the application(s) 120. In many embodiments, the instructions 120 will be written in an object-oriented language that is platform independent, such as the JAVA® programming language.

H. Invitations

The submission of an interaction 104 (which can also be referred to as a proposed interaction or a potential interaction) by the coordinator 102 causes the system 100 to generate an invitation 124 to the groups 116 and/or invitees 126 specified by the coordinator. An invitation 124 is what the system 100 creates from the proposed interaction 104. Thus, invitations 124 can be though of as processed interactions. If the interaction 104 specifies a group 116, the system 100 can be configured to automatically send invitations 124 to each invitee 126 in the group 116. In a preferred embodiment, invitations 124 are in the form of an e-mail message. However, instant messaging, automated telephone calls, faxed documents, the mailing of paper documents, announcements broadcast over a speaker, messages posted on a web site, and virtually any other means of communication can be used by the system 100 to convey invitations 124 and responses 128 to invitations 124).

Invitations 124 are conveyed to invitees 126 through invitee interfaces 120 accessed through invitee access devices 122. Invitations 124 can vary in the amount of information conveyed to invitees 126. A very basic invitation 124 may simply notify the invitee 126 of an upcoming interaction 104 without even prompting the invitee 126 to respond to the invitation 124. On the other end of the continuum, some invitations 124 could (1) require an affirmative or negative response; (2) provide the invitee with additional information relating to the interaction 104, such as the menu for the restaurant and the requisite payment mechanism for participating; (3) require that the invitee make their menu selections in responding; (4) inform the invitee of the deadline for responding; (5) provide payment to the vendor 118 (electronically or otherwise) and (5) provide and/or request any other information that could conceivably be relevant to the interaction 104 or the processing of the interaction 104 by the system 100.

A single interaction 104 submitted to the system 100 can result in multiple invitations 124 being sent to multiple invitees 126 in an automated manner without any human intervention. Such invitations 124 can also be sent in a simultaneous or substantially simultaneous manner.

I. Invitees

An invitee 126 is typically an individual human being who is considered to be part of a group 116 by a coordinator 102 invoking the functionality of the system 100. In some alternative embodiments, invitees 126 can themselves be groups 116 or organizations. In some embodiments, invitees 126 could be non-human beings such as pets or computational devices, such as robots, neural networks, artificial intelligence devices, or an automated scheduling application.

Invitees 126 can often be referred to as members within the system 100, because invitees 126 can be invited on the basis of their affiliation or membership with one or more groups 116. An invitee 126 who responds affirmatively to an invitation 124 can also be referred to as a participant because that person will be participating in the interaction 104. Invitees 126 with respect to a particular interaction 104 are potential participants with respect to the particular interaction 104.

In a preferred embodiment of the system 100, the invitee interface 120 is an e-mail, with invitations 124 and responses 128 being in the form of e-mail messages. In some embodiments, the system 100 can be configured to interact with the address book and calendar programs accessible from the invitee access device 122.

J. Response

A response 128 is generated by the invitee 126 in reaction to the invitation 124. In a preferred embodiment of the system 100, the system 100 captures the feedback from the individual invitees 126 in the form on a response 128 from each individual invitee 126. In some embodiments, the failure to respond can itself be considered a response 128 with respect to the processing performed by the system 100.

The amount of information provided in a response 128 can vary even more widely than the amount of information provided in the invitation 124. In a preferred embodiment, the response 128 is in the form of an e-mail. However, any of the communication mediums used to transmit invitations 124 can be used to transmit responses 128. The communication medium used in a response 128 need not match the communication medium used in the invitation 124.

In some embodiments, multiple conflicting responses 128 can be generated by the same invitee 126. For example, the availability of the invitee 126 may change with respect to the interaction 104. In some embodiments, the coordinator 102 can select from various constraints which may potentially limit the ability of invitees 126 to change their responses 128.

In many embodiments of the system 100, the response 128 will include answers to supplemental questions contained in the invitation 124. Such questions can be accompanied with a predetermined list of potential answers. For example, the invitee 126 could be asked to select one option from a menu of options included within the invitation 124.

K. Order

The system 100 generates an order 130 for a particular interaction 104 from the various responses 128 provided by the invitees 126. In some embodiments, the order 130 is generated automatically without any human intervention. In other embodiments, the coordinator 102 may wish to have the opportunity to review the order 130 before it is sent to the vendor 118. In either case, the system 100 can be configured to provide a notification to the coordinator 102 after the order 130 is sent to the vendor 118. In a preferred embodiment, the coordinator 102 includes a deadline in the invitations 124, and the order 130 is generated automatically upon the occurrence of the deadline. Other triggering events can be used to transmit orders 130. For example, the invitation 124 can be limited to first five invitees 126 who respond affirmatively, etc.

In the context of a restaurant order, the order 130 can include the menu selections made by the participating invitees 126 and in some cases, some form of electronic payment.

Vendors 132 access the orders transmitted by the system 100 through the vendor access device 132 and the vendor interface. In a preferred embodiment of the system 100, the vendor interface connects directly with the internal operating software used by the vendor 118.

II. Elements That Can Influence Interactions

The system 100 can be implemented in a wide variety of different ways. Depending on the goals and needs of coordinators 102, vendors 118, invitees 126, and the operators (such as an ASP) of the system 100, the system 100 can be configured to be sensitive to (or conversely to ignore) a wide variety of different processing elements. Thus, a wide variety of different elements can influence interactions 104 processed by the system 100.

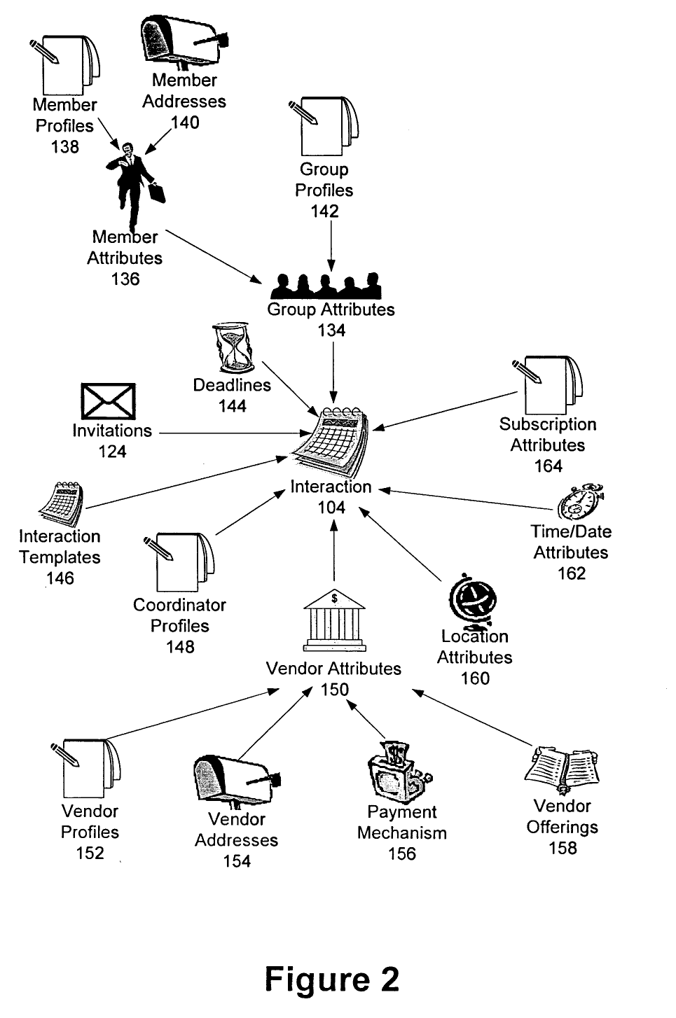

FIG. 2 is a data diagram illustrating examples of elements that can influence an interaction 104 processed by the system 100. Two typically significant factors in generating proposed interactions 104 that will result in invitations 124 being sent to invitees 126 are: (1) the groups 116 included on the invite list, and (2) the vendor(s) 118 involved in the interaction 104.

A. Group Attributes

One potentially relevant category of information relates to groups 116 and thus, can in the aggregate be referred to as group attributes 134. Group attributes 134 can include virtually any information relating to a group 116, including the list of members belonging to the group 116, the seniority of members within the group, the age of the group 116, the history of the group 116, and any other information that could be useful to the processing of the system 100.

In many embodiments of the system 100, group attributes 134 will include a group profile 142 that is defined by one or more members of the group 116. A group profile 142 can be used to set certain rules relating to the group 116. For example, a card playing group may traditionally play cards only on the weekends. Such preferences can be reflected in the group profile 142, and referenced by the system 100 to avoid sending out invitations 124 that conflict with the profile 142. Group profiles 142 can also take into consideration the history of a particular group's 116 use of the system 100. In some embodiments, the system 100 itself can modify a group profile 142 based on group history, without any input from any of the group's members.

B. Member Attributes

Group attributes 134 can also include information relating to the individual members of the group 134. Information relating to individual members can be referred to as member attributes 136. Member attributes will commonly include a member address 140 (e.g. an e-mail address, a mailing address, a phone number, a fax number, a cell phone number, or some other information related to the facilitation of communicating with the member) as well as a member profile 138. Member profiles 138 can include stated preferences of the member 138 as well as traits about the member identified by the system 100 in the course of the member's (e.g. invitee's) interactions with the system 100. For example, the member profile 138 can include information about the types of foods that a particular member (e.g. invitee 126) likes, or conversely foods that the member is allergic to.

An invitee 126 can be a member of more than one group 116. Thus, an invitee 126 can possess more than one member profile 138. In many respects, the member 138 can be thought of as a “role” for that invitee 126 with respect to the particular group 116.

C. Deadlines

An interaction 104 can include one or more deadlines 144 with respect to invitee 126 responses 128. For example, the invitees 126 might be required to answer yes or no within a certain period of time, while being provided the flexibility to make their menu selections as late as merely 3 hours before the interaction 104. Deadlines 144 are typically set by either coordinators 102 or vendors 118. In some embodiments, deadlines could also be set by groups 116, individual invitees 126, or the ASP. For example, the member profile 140 for a particular invitee 126 may request that a certain amount of lead time be included in any invitation 124. If that lead time requirement cannot be satisfied, the system 100 can be configured not to invite that member.

D. Invitations

The contents of the invitation 124 and the desired format of the invitation 124 can influence the resulting interaction 104. For example, invitations 124 can include personalized messages to the invitees 126 that are based on member profiles 138 for those individuals. The constraints set by the coordinator 102 as communicated in invitation 124 can impact the manner in which the system 100 processes the interaction 104. The varying capabilities of invitations 124 are discuss above.

E. Interaction Templates

In order to facilitate the effective and efficient use of the system 100 by a coordinator 102, the system 100 can be configured to support one or more interaction templates 146. An interaction template 146 in many instances is a partially finished interaction 104 that provides the coordinator 102 with a convenient starting point for creating a potential interaction 104 to be submitted to the system 100. For example, if a particular group 116 routinely convenes at the same Broadway theatre on the first Friday of each month, an interaction template 146 could be created to reduce the repetitive data entry needed to submit the desired interaction 102. In some embodiments, past interactions 104 can serve as interaction templates 146. It can also be possible to submit potential interactions 104 that are configured to occur multiple times at a certain predefined frequency (e.g. weekly, monthly, quarterly, annually, etc.).

F. Coordinator Profiles

In some embodiments of the system 100, the wants and desires of coordinators 102 are anticipated by the system 100 through the use of coordinator profiles 148. A coordinator profile 148 can be influenced by the expressed desires of the coordinator 102 as well as implicitly by the history of the coordinator's 102 interactions with the system 100.

For example, if a particular coordinator 102 routinely requires responses 128 within 24 hours, the system 100 could be configured to create such a deadline 144 by default.

G. Vendor Attributes

The system 100 can also make processing distinctions relating to the specific characteristics of the vendor 118 involved in a particular interaction 104. Such information can be referred to as vendor attributes 150, and any information relating to the vendor 118 that is potentially relevant to the processing performed by the system 100 can constitute a vendor attribute 150. Vendor attributes 150 can include one or more vendor profiles 152, one or more vendor addresses 154, one or more payment mechanisms 156, and one or more vendor offerings 158.

Just as other forms of profiles can be influenced directly by affirmative selections as well as indirectly through the history of interactions with the system 100, vendor profiles 152 can involve both selection-based and history-based influences. For example, the vendor 118 may decide that it will be closed on Sundays. In such a circumstance, the system 100 could be configured to prevent the sending of invitations 124 to invitees 126 for a interaction 104 to occur on a Sunday. Vendor profiles 152 are a means by which vendors 118 can create processing rules with respect to orders 130 and searches relating to the vendor 118. For example, certain vendors 118 may desire notification at various points in the interaction 104/invitation 124/order 130 process to avoid be caught by surprise on a substantial order 130. Vendors may also create certain minimum and even maximum constraints on online orders 130.

A vendor address 154 is typically an e-mail address, although phone numbers and other types of communication and contact information can serve as vendor addresses 154.

Other vendor attributes 150 that are typically important to the processing of the system 100 relate to the payment mechanisms 156 accepted by the vendor 118 and the particular vendor offers 158 made available by the vendor 118. Some vendors 118 participating in the system 100 could decide to require electronic payments through the system 100 in advance of the interaction 104. Other vendors 118 may permit any type of payment, without requiring any type of deposit in advance of the interaction 104. Payment mechanisms 156 and payment policies can vary widely from vendor 118 to vendor 118, but the system 100 can configured to support the differing desires of the participating vendors 118.

Similarly, the system 100 can also support a wide array of different vendor offerings 158. The system 100 can support the active participation of a wide variety of different vendors 118. An amusement park has significantly different vendor offerings from a fancy French restaurant. Even within the classification of “restaurant” the system 100 can support a wide variety of distinctions between vendors 118. For example, different restaurants will have different menus.

H. Location Attributes

A potential interaction 104 is also defined by information relating to the location of the interaction 104 (e.g. location attributes 160). Location attributes can be identified generally, such as by a name of the vendor 118. However, it will often be desirable to include more detailed information, such as a street address. In some circumstances, the location of a particular interaction 104 could be as specific as a particular table within a restaurant.

I. Time/Date Attributes

A potential interaction 104 is also defined by information relating to the date and time at which the interaction 104 is to take place. Different systems 100 may specific the time/date attributes 162 to different degrees of precision. To some extent, the degree of precision may be dictated by the vendor 118, or in other circumstances, it may be the sole discretion of the coordinator 102.

J. Subscription Attributes

If the system 100 is being provided on a subscription basis, information relating to the subscription can impact the processing of the interaction 104. For example, if all participating vendors 118 execute subscription contracts with the ASP supporting the system 100, there may be aspects of those subscription contracts that influence the processing of a particular interaction 104. One typical example of a subscription attribute would a contract clause allowing a vendor 118 to set minimum purchase requirements for interactions 104 involving that particular vendor.

In embodiments where the coordinator 102 is the subscriber, it would be possible for the ASP to set a limit to the number of potential interactions 104 or invitations 124 could be generated over a particular period of time. The system 100 could thus be configured to automatically enforce the limitations set forth in the subscription contract between the coordinator 102 and the ASP.

III. Elements That Can Influence Orders

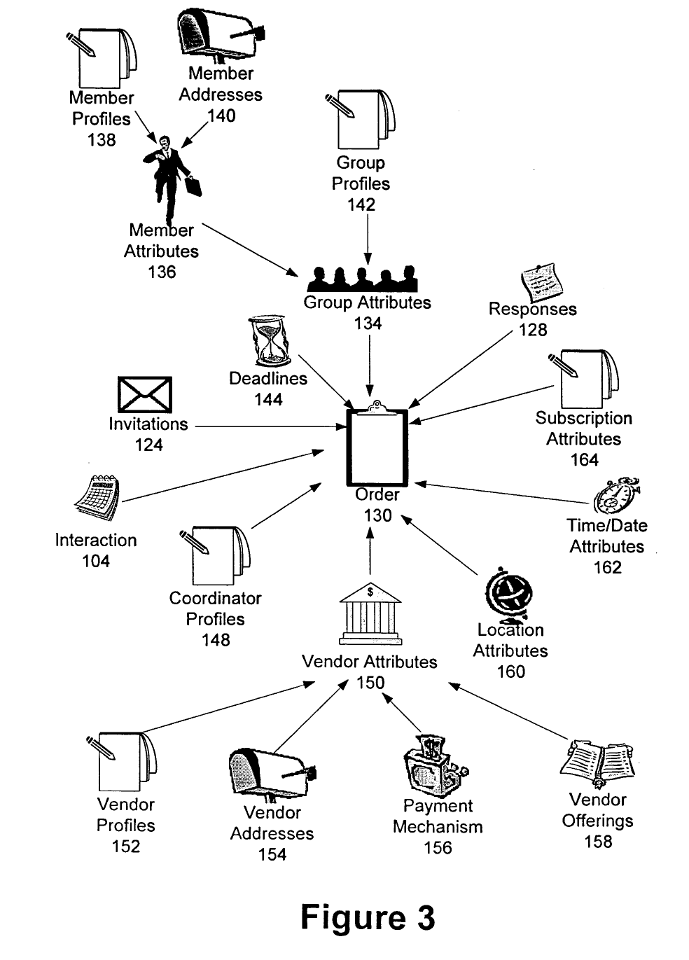

Just as the system 100 can be configured to allow the processing of interactions 104 (and potential/proposed interactions 104) to be influenced by a potentially wide array of different elements, a similarly broad array of elements can influence the orders 130 generated by the system 100. FIG. 3 is a data diagram illustrating examples of elements that can influence an order 130 generated by the system 100.

FIG. 3 is very similar to FIG. 2 discussed above. However, unlike proposed interactions 104 which represent the input of the coordinator 102, orders 130 are generated as output by the system 100 at the other end of the processing cycle, and thus orders 130 are also influenced by the responses 128 of invitees. The impact and influence of responses 128 on orders 130 generated by the system 100 can vary even more widely than the different types of responses 128 that can be provided to the system 100.

By way of example, if a response 128 includes menu selections for a restaurant reservation, the order 130 will include that information. Similarly, if the response 128 includes an electronic payment, that payment can be included in the order 130.

IV. Process-Flow Views

A. From the Perspective of a Coordinator

FIG. 4 is a flow chart diagram illustrating an example of a process flow from the perspective of a coordinator 102.

At 200, a group 118 is defined on the system 100. Typically, the minimal amount of input needed to define a group 118 is to assign at least one member to the group. Some embodiments of the system 100 can be configured to support groups 118 that do not possess any members. However, such groups 118 cannot be used as the basis to distribute invitations 124 since no invitees 126 would be on the distribution list for the particular invitation 124.

At 202, invitations 124 are created using the inputs (e.g. the potential interaction 104) provided by the coordinator 102 in conjunction with the process rules of the system 100. This step can be fully automated in certain embodiments if the potential interaction 104 is a periodically repeating interaction 104.

At 204, invitations 124 are submitted for delivery by the system 100. The types of information included in the invitations 124, and the processing parameters associated with responding to the invitations 124, can vary widely as discussed above.

At 206, the coordinator 102 receives a report regarding the order 130 that was generated by the system 100 as a result of the various responses 128 received by the system 100. In some embodiments, the coordinator 102 can configure the submission of the potential interaction 104 so that no orders 130 are sent to any vendors 118 without the coordinator 102 first approving the orders 130.

Upon receipt of the report at 206, the process ends.

B. From the Perspective of a Vendor

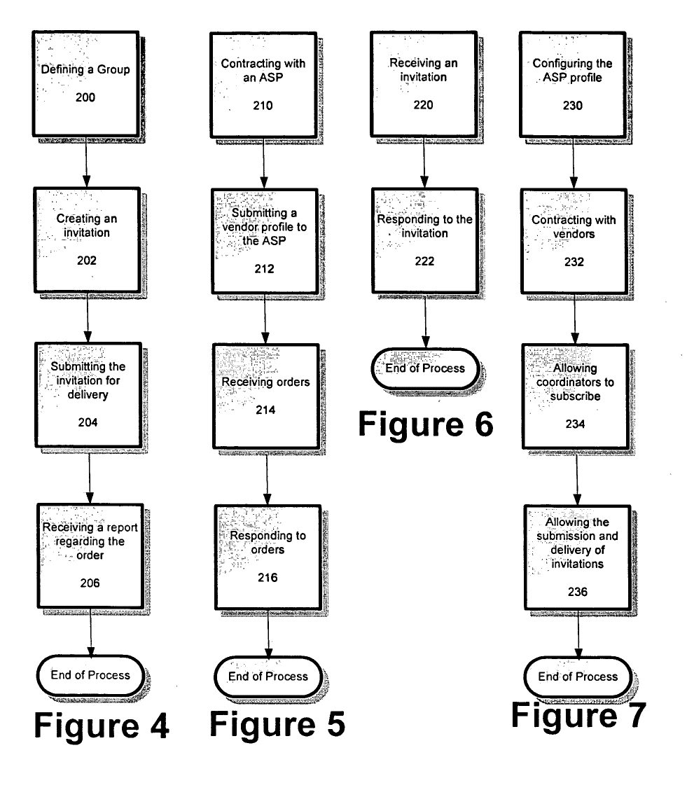

FIG. 5 is a flow chartv diagram illustrating an example of a process flow from the perspective of a vendor 118.

At 210, the vendor 118 contracts with an ASP in order for the vendor 118 to be listed on the system 100 as a potential vendor 118. This process can involve intense negotiation, and aspects of the subscription can be used to customize the processing performed by the system 100. Subscription attributes 164 are described above.

At 212, the vendor 118 submits vendor-specific information to the ASP for the purposes of properly configuring the automated processing of the system 100. For example, any minimum purchase amounts, payment mechanism 156 requirements, lead time notification requirements, and vendor offerings 158 may need to be accurately represented within the system 100.

At 214, the vendor 118 receives the orders 214 generated by the system 100 in response to the invocation of the system 100 by one or more coordinators 102.

At 216, the vendor 118 responds to the orders 214 consistent with the order 130 submitted by the system 100, the parameters set forth by the vendor 118 with respect to the system 100, and the business practices of the vendor 118. After the order is fulfilled, the process ends.

C. From the Perspective of an Invitee

FIG. 6 is a flow chart diagram illustrating an example of a process flow from the perspective of an invitee 126.

At 220, the invitee 126 receives an invitation 124. As discussed above, invitations 124 can be sent and received in a wide variety of different formats, while providing a different array of information to the invitee 126.

At 222, the invitee 126 generates a response 128 to the invitation 124. In some embodiments of the system 100, the invitee 126 can configure their member profile 138 to automatically respond to invitations 124 in a manner that is consistent with their availability as indicated in an electronic calendar as well as the processing rules set forth in the member profile 138.

After the response 128 is sent, the process in many embodiments is completed. In other embodiments, the invitee 126 may be prompted to provide an electronic payment to the vendor. In still other embodiments, the invitee 126 may be prompted to provide additional follow-up information to the system 100 or directly to the vendor 118. If desirable, the system 100 can be configured to provide a notification of outgoing orders 130 to the invitees 126 as well as to the coordinators 102.

D. From the Perspective of an ASP

FIG. 7 is a flow chart diagram illustrating an example of a process flow from the perspective of an Application Service Provider (“ASP”).

At 230, the ASP configures an ASP profile setting forth the particular processing rules for the system 100.

At 232, the ASP contracts with different entities (typically vendors 118) in order to populate the system 100 with potential vendors 118 for interactions 104.

At 234, the ASP allows coordinators 102 to subscribe to the system 100. In order to protect the potentially confidential nature of the groups 116 defined by various coordinators 102, the coordinators 102 should preferably be required to login to the system 100 with a login ID and password before being allowed to access the corresponding group attributes 134.

At 236, after the necessary information is entered with respect to vendors 118 and groups 116, the system 100 can begin to allow coordinators 102 to initiate the creation and delivery of invitations 124. The process is then competed from the perspective of the ASP.

E. From the Perspective of the Overall System

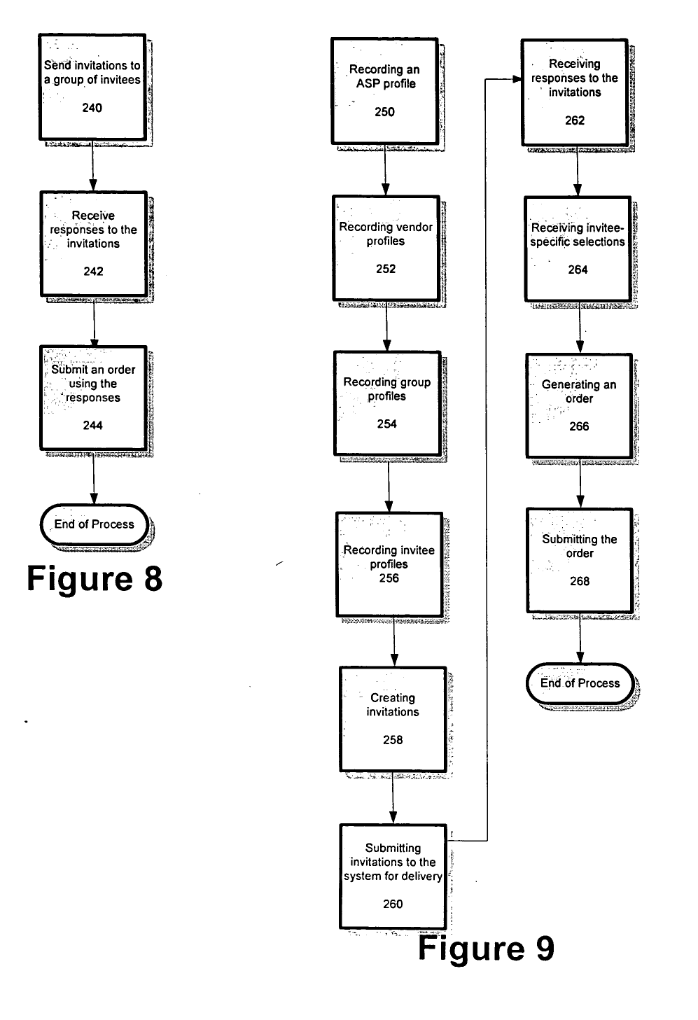

FIG. 8 is a flow chart diagram illustrating an example of a process flow from the perspective of the overall system 100.

At 240, an invitation 124 is sent to a group 116 of invitees 126 by the system 100.

At 242, the system 100 receives a response 128 to the invitations 124.

At 244, the system 100 submits an order 130 to the vendor 118 using the responses 128, after which the process ends.

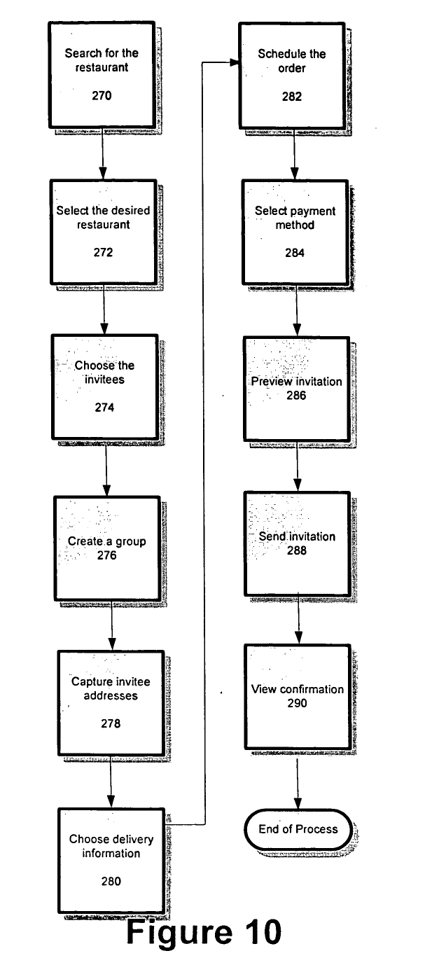

FIG. 9 is a more detailed flow chart diagram illustrating a second example of a process flow from the perspective of the overall system 100.

At 250, an ASP profile is recorded, establishing many of the processing rules for the system 100.

At 252, vendor profiles 152 and other initial startup vendor attributes 150 are inputted into the system 100.

At 254, group profiles 142 and other initial startup group attributes 134 are defined within the system 100.

At 256, invitee profiles (e.g. member profiles 138) and other initial startup member attributes 136 are defined within the system 100.

At 258, invitations 124 are created by the system 100 using the processing rules configuring the system 100, and the potential/proposed interaction 104 submitted through the coordinator interface 108.

At 260, the invitations 124 are delivered by the system 100.

At 262, the system 100 receives responses 128 to the invitations 124 generated by invitees 126 utilizing one or more invitee interfaces 120.

At 264, the system 100 receives the invitee-specific selections. This step is in many embodiments, combined with the processing at 262.

At 266, the system generates an order 130 using the responses 128 and the invitee-specific selections. The order 130 is then submitted at 268, after which the ordering process can end. In some embodiments, the system 100 can be configured to perform various post-interaction reporting functions. Vendors 118, the ASP, the coordinator 102, and even invitees 126 may be interested in receiving various reports relating to their use of the system 100.

F. A Restaurant Example

FIG. 10 is a detailed flow chart diagram illustrating a process flow from the perspective of the overall system 100 in the context where the vendor 118 is a restaurant.

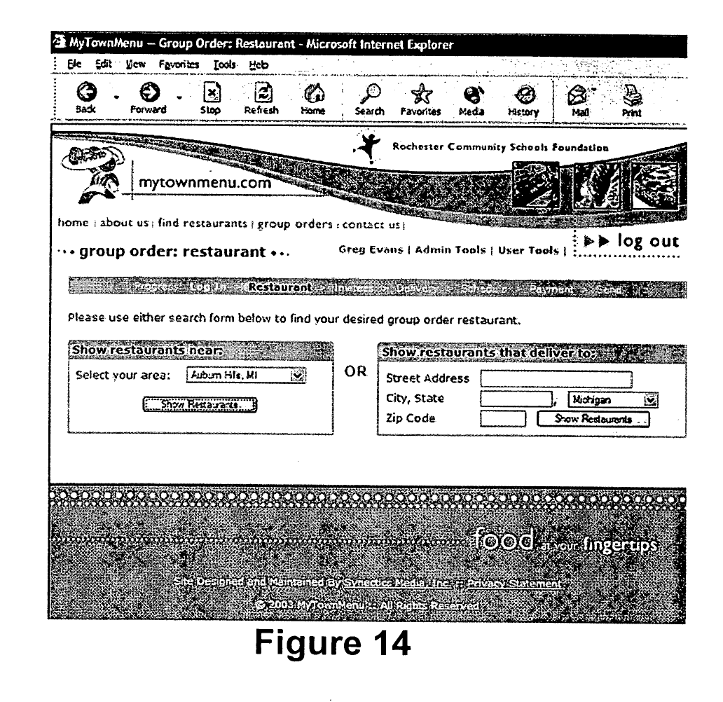

At 270, the coordinator 102 performs a search using the system 100. In a preferred embodiment, searches can be performed using a variety of different search criteria, including potentially city, delivery zone, type of food, price range, operating hours, etc. An example of a search screen is displayed in FIG. 14 and is discussed below.

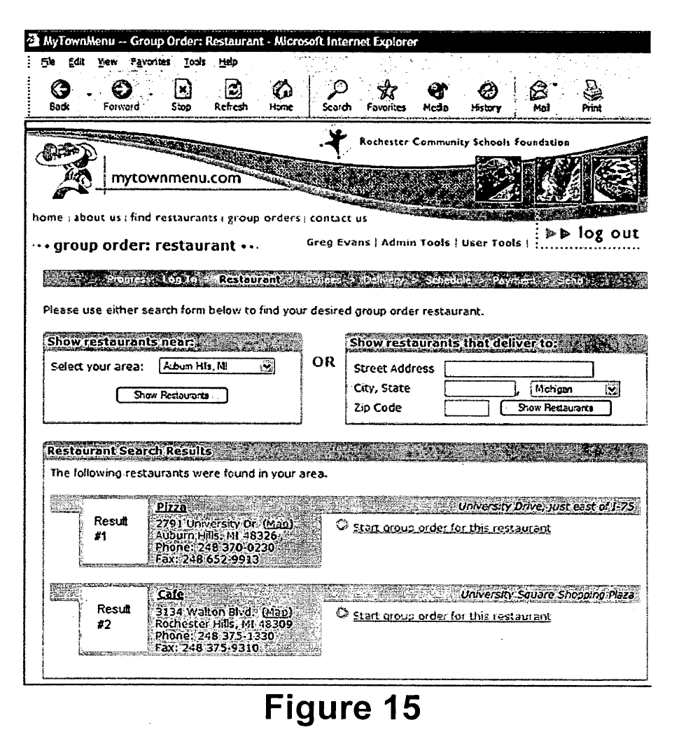

Returning the FIG. 10, a restaurant can be selected at 272 for the interaction 104 from a list of restaurants provided by the system 100 in response to the search performed at 270. An example of a search results screen is displayed in FIG. 15 and is discussed below.

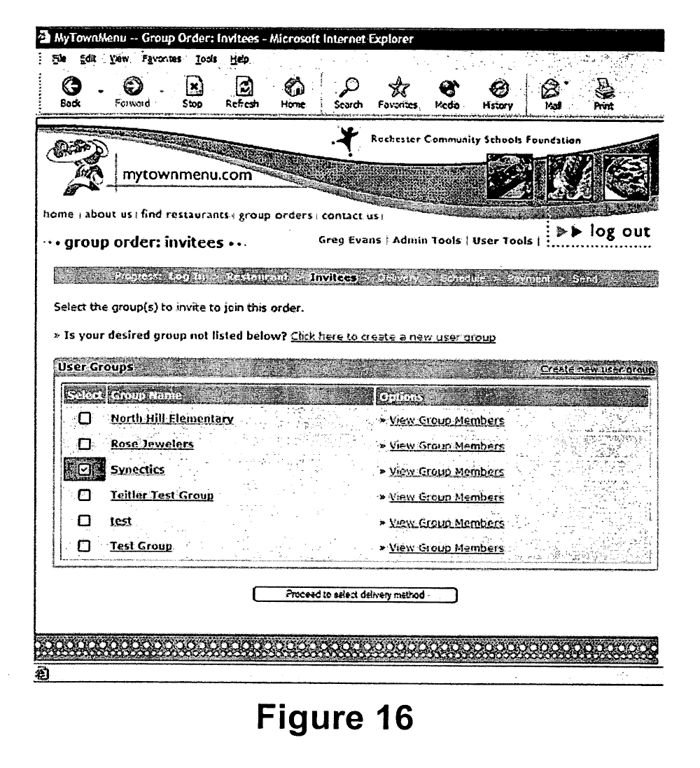

Returning to FIG. 10, the invitees 126 for the proposed interaction 104 are selected at 274. Invitees 126 can be selected for the proposed interaction 104 on the basis of an affiliation or membership with a group 116, or because of some individual characteristic specific to the invitee 126. An example of an invitee selection screen is displayed in FIG. 16 and is discussed below.

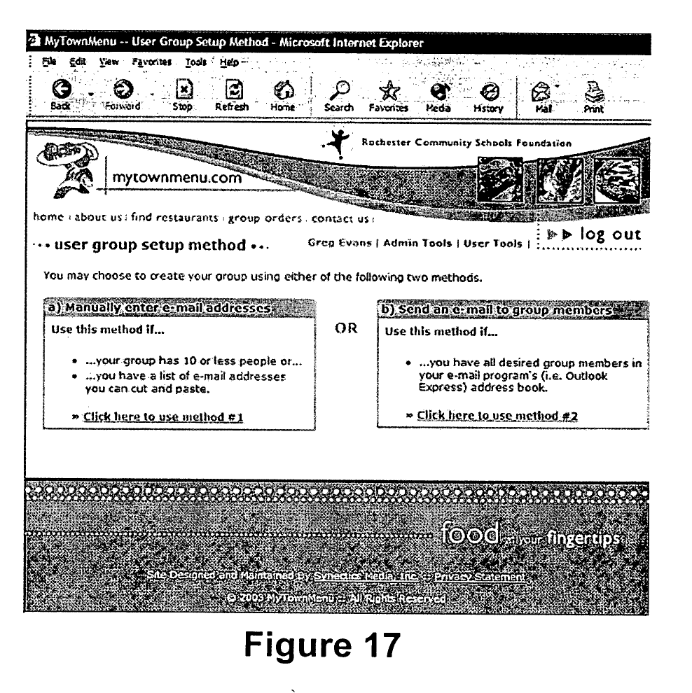

Returning to FIG. 10, the system 100 at 276 can create new group 116 affiliations or modify existing groups 116 that have already been created and saved using the system 100. At 278, the coordinator 102 can be given several different options for populating a particular group 116 with member addresses 140. Different embodiments of the system 100 can provide coordinators 102 with different options. One possibility is that the coordinator 102 already possesses the required e-mail addresses, and can simply copy and paste them into system 100. In a preferred embodiment, coordinators 102 can copy and paste multiple member addresses 140 simultaneously. Another possibility is that an address book on the coordinator's 102 access device 106 can be used to provide the desired member addresses 140. Still another option is to ask the individual members to access the web site or other location of the invitee interface 120 and provide their contact information (the invitee 126 could be asked to populate the system 100 with other member profile 138 information at that time). FIGS. 17-20 provide examples of screens that can be used to populate the system 100 with desirable member address 140 information.

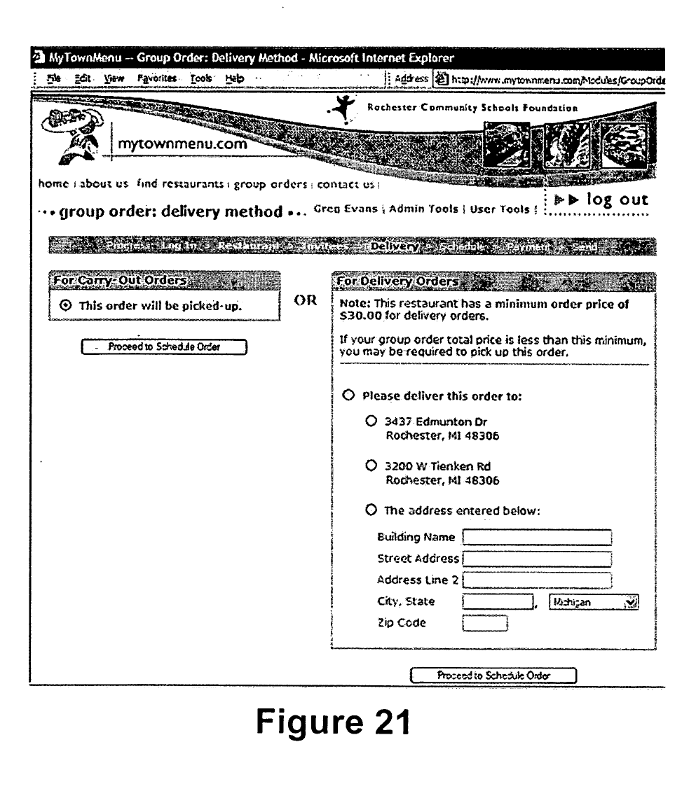

Returning to FIG. 10, the system 100 at 280 allows the coordinator 102 to choose among various delivery options. The delivery options available to the coordinator 102 for a particular restaurant selection can depend on several factors, including but not limited to: (1) the delivery range of the vendor 118 as identified by in the vendor 118 in their vendor profile 152; (2) the search criteria supplied to the system 100 at 270; and (3) the aggregate impact of other processing rules and profiles. FIG. 21 displays an example of a screen used to select delivery options.

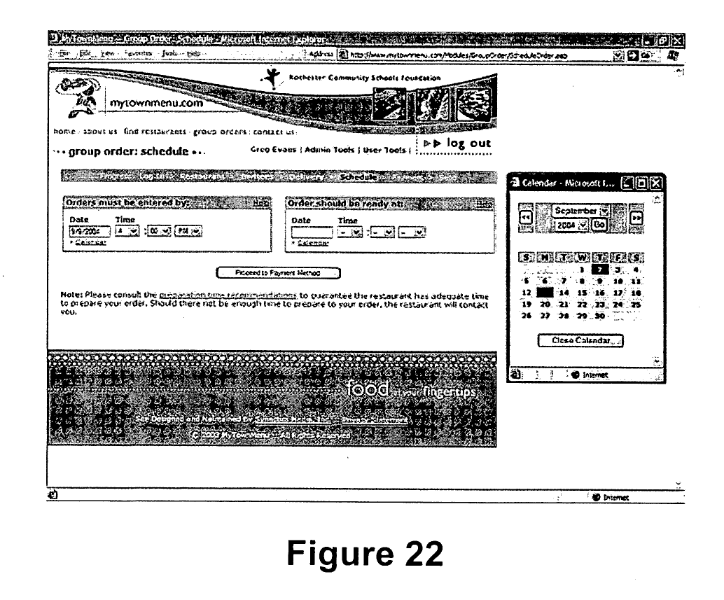

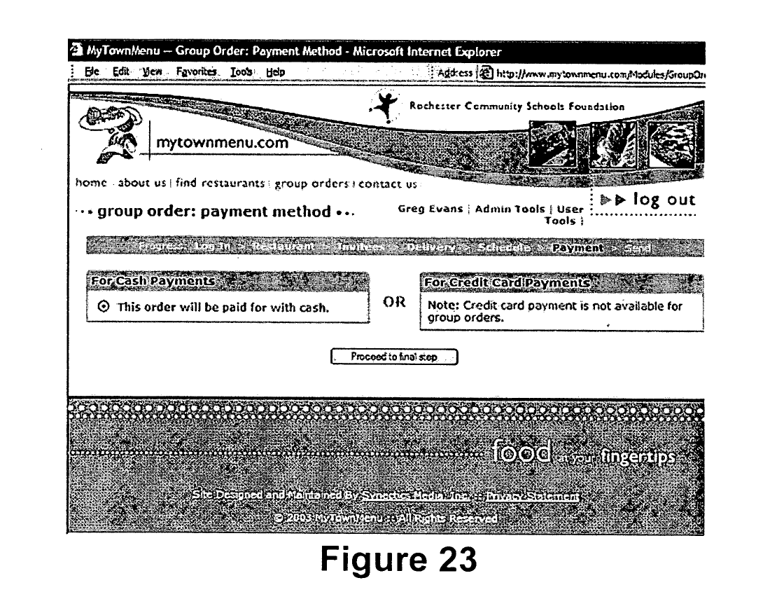

Returning to FIG. 10, the coordinator 102 may then schedule the order 130 at 282. This can involve setting deadlines 144, identifying the text to be included in the invitations 124, defining a minimum and a maximum number of participants, etc. FIG. 22 displays an example of a scheduling screen.

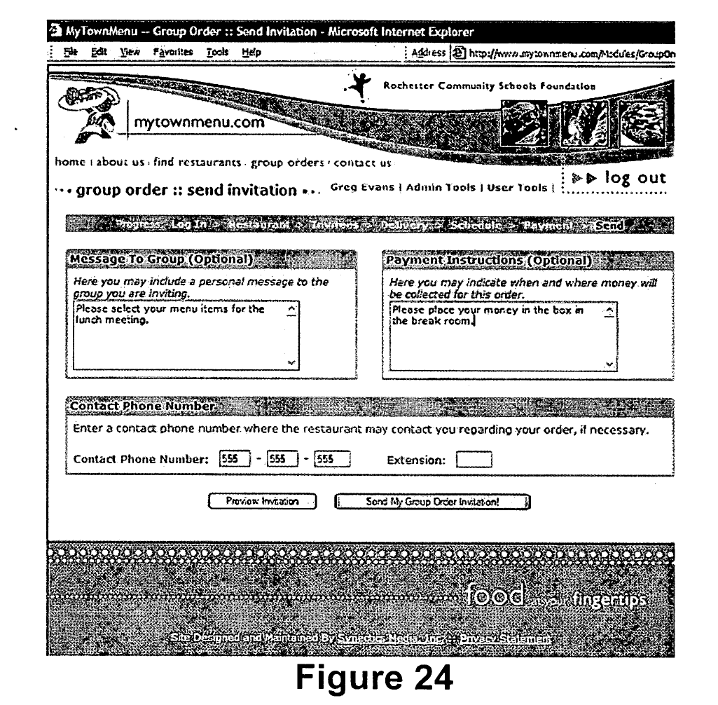

At step 284 of FIG. 10, the coordinator 102 can select the appropriate payment method. As discussed above, payment mechanisms 156 and payment requirements can be defined by the restaurant. They can also be part of the search criteria submitted by the coordinator 102 at 270. Thus, in certain circumstances, there may not be more than one valid payment option at 284. FIG. 23 displays an example of a payment method screen in which there are two valid payment options for the coordinator 102 to select from. Payment instructions can be included in the invitation 124, as illustrated by the example in FIG. 24.

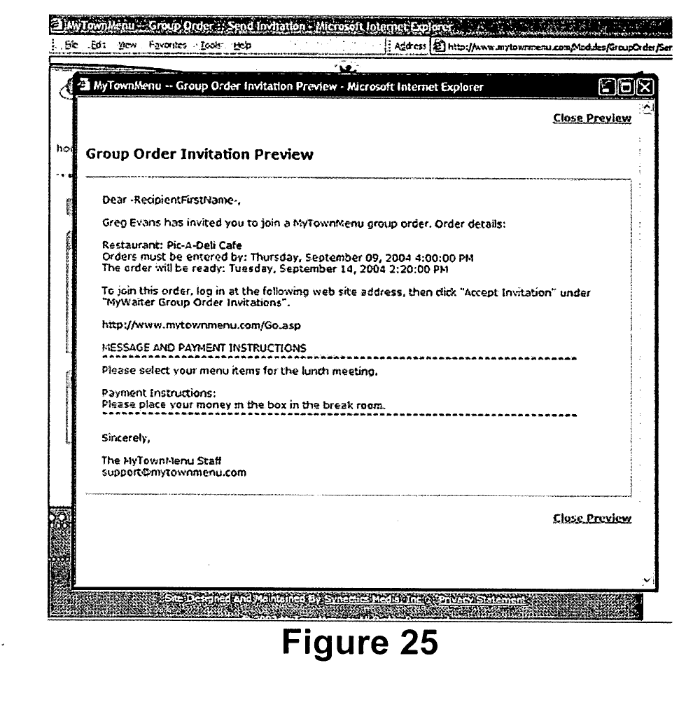

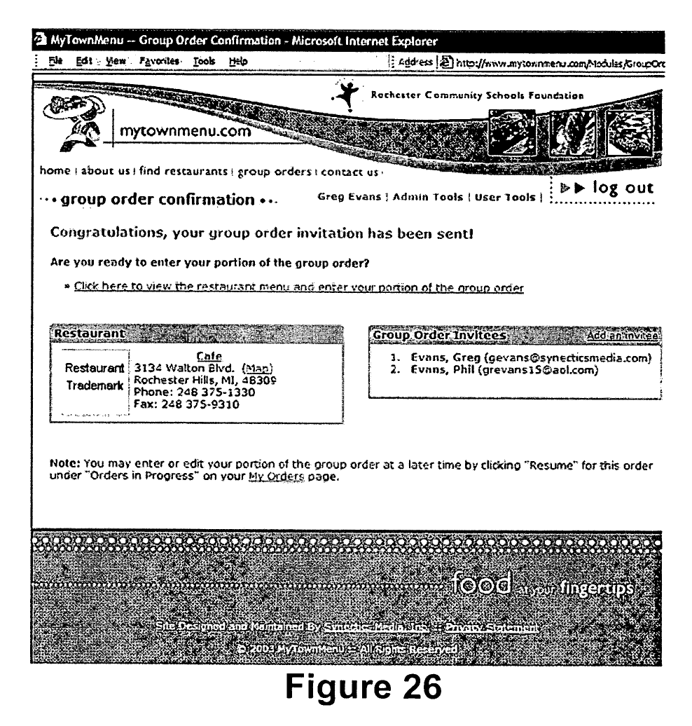

At 286 of FIG. 10, the coordinator 102 can preview the invitation 124 that will be received by the invitees 126. An example of an invitation preview screen is provided in FIG. 25. If desired, the invitation 124 needs to be modified or deleted by the coordinator 102 at 124. Otherwise, the invitation can be sent at 288. A confirmation notice is sent to the coordinator at 290, after which the order 130 can be automatically sent to the restaurant in accordance with any deadlines 144 set by the coordinator 102. The process of the group order is then complete, and processing can terminate.

V. Subsystem-Level Views

A. Entity-Organization Perspective

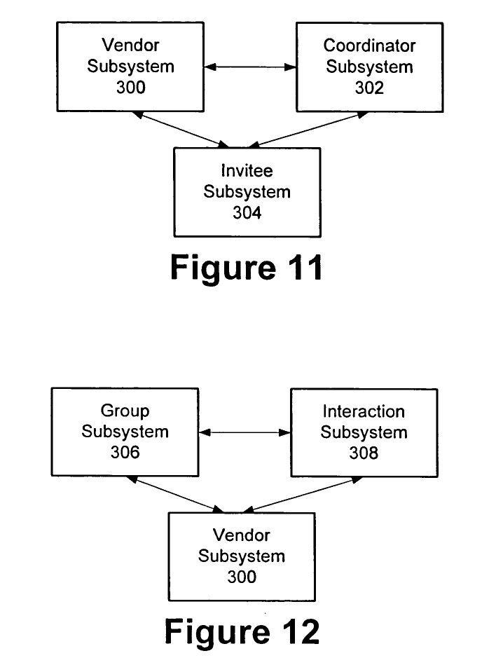

FIG. 11 is a block diagram illustrating an example of a subsystem-level view of the system 100. The system 100 can be implemented in the form of subsystems that focus on the different entities interacting with each other using the system 100. Thus, vendors 300 can interact with the system 100 through a vendor subsystem 300 and coordinators 302 can interact with the system 100 through a coordinator subsystem 302. In many embodiments, the invitee's interaction with the system 100 is limited to receiving e-mail invitations 124 and sending e-mail responses 128. Thus, the invitee subsystem 304 is not a required component of the system 100. However, if an embodiment of the system 100 is to incorporate sophisticated invitee-based customizations based on the invitee profile 138, the invitee subsystem 304 can be used to create, modify, and delete such information.

1. Vendor Subsystem

The vendor subsystem 300 can be responsible for adding, creating, modifying, and deleting all vendor attributes 150 in the system 100. In most circumstances, vendors 118 should not be able to modify create, modify, delete, or even view information that relates to other vendors 118. As discussed above, the processing rules set through the vendor subsystem 300 can determine: the offerings 158 that can be purchased through the system 100; the payment mechanisms 156 that can be used to pay for orders 130 sent using the system 100; the particular vendor addresses 154 that should be used in a particular situation; the fees to be paid to the ASP; etc. The rules for the system 100 set by the ASP determine what options may be available to which vendors 118. However, the vendor selections made through the vendor subsystem 300 can impact the parameters that constrain both the coordinator subsystem 302 and the invitee subsystem 304. Consistent with contract law, vendors 118 are offerors, and thus vendors 118 need to be the masters of their offers if they are to participate in the system 100.

In some embodiments of the vendor subsystem 300, the system 100 is configured to provide the vendor 118 with a notification when certain events occur, such as the sending out of invitations 124, the receipt of a predefined number of responses, etc. Different vendors 118 may desire to implement vastly different notification rules within the scope of a single embodiment of the system 100.

2. Coordinator Subsystem

A coordinator subsystem 302 is the driving mechanism by which interactions 104 are submitted to the system 100 so that invitations 124 can be sent to invitees 126 and responses 128 ultimately received. Unlike the vendor subsystem 300 and the invitee subsystem 304, the coordinator subsystem 302 is not primarily reactive. In addition to the defining group/member relationships and the ability to initiate interactions 104, the coordinator subsystem 302 identify potential vendors 118 using search criteria; create, modify, delete, and view coordinator profiles 148; create, modify, delete, and view group profiles 142; capture member attributes 136; provide predefined questions with predefined answer parameters (typically multiple choice answers) to invitees 126 within the invitation 123; set time/date attributes 162; set location attributes 160; create, modify, delete, and view interaction templates 146; define an interaction 104 as a reoccurring interaction 104; embed payment instructions with invitations 124; preview invitations; define a group 118 as belonging to another group 118; review responses 128; review orders 130; and related processing identified above.

3. Invitee Subsystem

The invitee subsystem 304 can be used to receive invitations 124, generate responses 128 to those invitations 124, and to supply the system 100 with member attributes 136 (e.g. invitee attributes) such as profile information 138 and address information 140.

Depending on the sophistication of the member profile 138, the system can be configured to share information with address book, calendar, and other relevant scheduling programs that are accessible from the invitee access device 122. The member profile 138 can in some circumstances be used to provide default selections in generating responses 128, and in certain circumstances, to automatically generate and transmit the response 128 without any intervention from the invitee 126. The invitee 126 can use the invitee subsystem 126 to generate reports relating to the invitee's 126 use of the system 100.

B. Data-Relationship Perspective

FIG. 12 is a block diagram illustrating a second example of a subsystem-level view of the system 100. The example in FIG. 12 uses a subsystem configuration based on the type of data being process instead of the entities interacting with the system 100. The example in FIG. 12 includes the vendor subsystem 300 because vendor attributes 134 are a key data component to the functioning of the system 100.

1. Group Subsystem

A group subsystem 306 focuses on the relationships between groups 116 and members (e.g. invitees 126), and the corresponding member attributes 136 and group attributes 134. Thus, the group subsystem 306 can also be referred to as the member subsystem, the participant subsystem, or the relationship subsystem.

The group subsystem 306 is similar to the vendor subsystem 300 in that both subsystems are used to create, modify, delete, and view a library of information that forms part of the framework upon which interactions 104, invitations 124, and orders 130 are processed. Both the group subsystem 306 and the vendor subsystem 300 are used to populate the system 100 with data, providing a playing field and foundation for the operation of an interaction subsystem 308.

2. Interaction Subsystem

An interaction subsystem 308 is the subsystem which facilitates the creation, modification, deletion, and viewing of interactions 104, the catalyst for the system 100 to generate invitations 124 and orders 130. Thus, the interaction subsystem 308 can also be referred to as the invitation subsystem or the order subsystem. In contrast to the vendor subsystem 300 and the group subsystem 306, the interaction subsystem 308 is not a passive component of the system 100. To the contrary, it directly performs the functionality sought by the coordinator 102. The interaction subsystem 308 can perform the functions identified above with respect to the coordinator subsystem 302.

VI. Interface Views

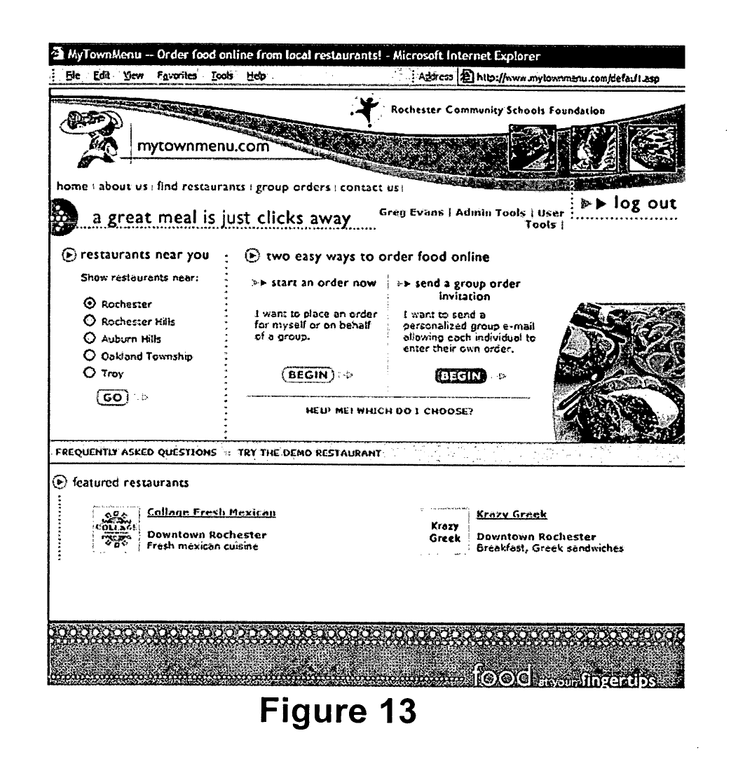

As discussed above, the system 100 can be implemented in a wide variety of different ways using a wide variety of process rules and interfaces. To some extent, different processing rules and contexts will influence the desired interfaces used by the system 100. FIGS. 13-26 provides examples of interface views in the context of a group ordering system for food related purchases. With different categories of vendors 118, different interfaces could be desirable or even required.

FIG. 13 is a screen print illustrating an example of a group ordering system 100 where the vendors 118 are in the restaurant and catering industry. To initiate a group order, the coordinator 102 must merely access the coordinator interface 108 and click “send a group order invitation.”

A. Vendor Search Screen

FIG. 14 is a screen print illustrating an example of a restaurant search in a coordinator interface 108.

From this screen, the coordinator 102 searches for his desired restaurant. He can choose to retrieve a list of restaurants by city, or he can find restaurants that will deliver to a particular address. Different embodiments of the system 100 may provide a different array of search options.

B. Display Search Results Screen

FIG. 15 is a screen print illustrating an example of a search result generated by the system 100 and displayed in a coordinator interface 108.

Once the coordinator 102 has searched for a list of restaurants in the desired area area, the coordinator 102 can click on the restaurant of his choice to start a group order invitation 124.

Different embodiments with use different processing rules and algorithms in how the various vendors 118 are listed on this screen. In a preferred embodiment, vendors 118 pay more for more favorable placement.

C. Invitee/Group Selection Screen

FIG. 16 is a screen print illustrating an example of an invitee/group screen in a coordinator interface 108.

After choosing a restaurant, the coordinator 102 can specify who should receive invitation 124. The coordinator 102 may either select a group 116 that he has already created or choose to create a new group 116. If the coordinator 102 clicks “create a new user group,” he can choose from one of three methods as shown below in FIGS. 17-19.

D. Group Setup Screen

FIG. 17 is a screen print illustrating an example of a group setup screen in a coordinator interface 108.

Once the coordinator 102 chooses to create a new group 116, the coordinator 102 is taken to this screen where one of two methods (there are two methods in this particular embodiment) can be used to create the new group 116. Method one actually has presents two distinct options by which the coordinator 102 can “manually” enter the e-mail addresses. Method two allows the coordinator 102 to automatically import his e-mail addresses.

E. Group Maintenance Screen

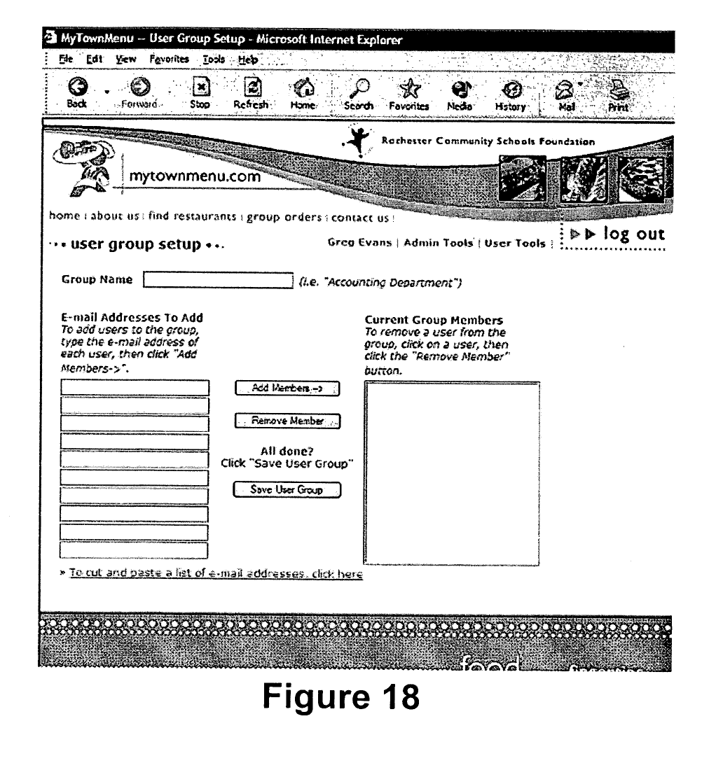

FIG. 18 is a screen print illustrating an example of method one—two distinct options for entering in member e-mail addresses 140.

The first option consists of manually entering addresses 140. The coordinator 102 user can enter e-mail addresses 140 on the left side of the screen and click “Add Members.” The addresses 140 are then put into the list on the right. After specifying a group name and clicking “Save User Group,” the list is saved for use during the current order 130 as well as future orders 130.

If the coordinator 102 has a significant number of e-mail addresses 140 to add, the coordinator 102 may choose to invoke option two (the “copy and paste” option) to populate the addresses 140.

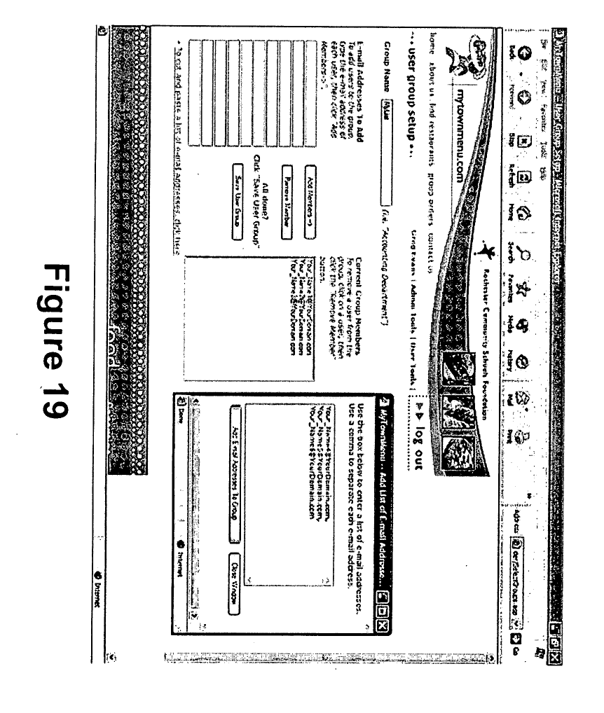

FIG. 19 is a screen print illustrating an example of the screen that appears using the “copy and paste” option for entering invite e-mail addresses 140 using the coordinator interface 108.

If the coordinator 102 clicks the link to “cut and paste a list of e-mail addresses,” the dialog box on the right of the screen pops up. This dialog box allows the coordinator 102 to cut and paste a list of e-mail addresses 140 into the box. Once the coordinator 102 clicks the “Add E-mail Addresses to Group” button, the addresses 140 are added to the current list.

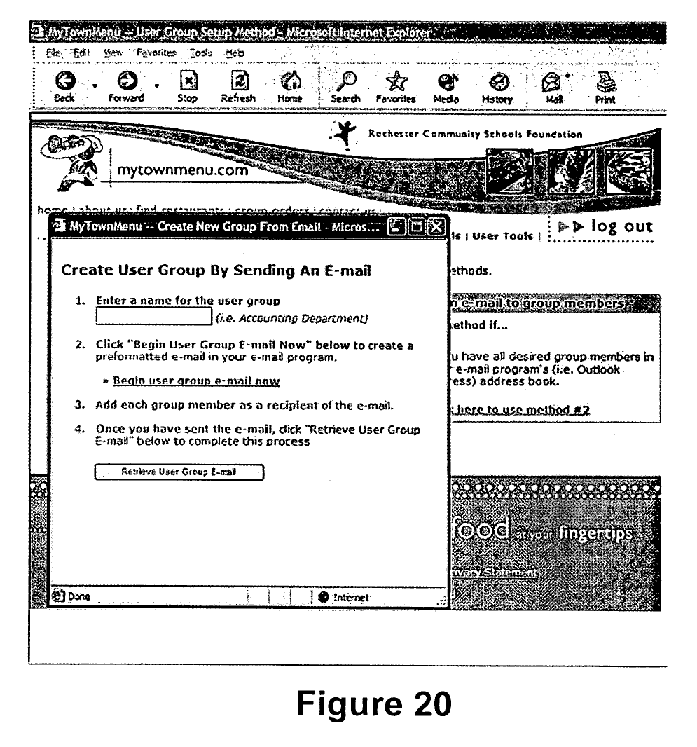

FIG. 20 is a screen print illustrating an example of method two (e.g. an “address capture mechanism”) that can be invoked through the coordinator interface 108.

If a coordinator 102 does not want to type in the e-mail addresses 140 for his group 116, the coordinator 102 can utilize the addresses 140 stored in an address book accessible from the coordinator access device 106 to populate the database 114. This method allows the coordinator 102 to create an automatic preformatted e-mail to send to the desired group 116. This e-mail serves several purposes. First, it informs the Invitees about the services accessible from the system 100 and lets them know that they are being added as a member of a group 116. Second, it lets them know how they can also use the service in the future and the benefits of the service. Third, it allows them to define their member profile 138 if they desire to do so. Fourth, the e-mail address 140 is copied to a database and recorded as the member address 140 for the particular member. After reading the e-mail address 140, the server 110 then creates the group 116 under the appropriate coordinator 102 account.

F. Delivery Selection Screen

FIG. 21 is a screen print illustrating an example of a delivery method selection screen in a coordinator interface 108.

At this screen, the coordinator 102 can choose to either have the order 130 delivered to a physical address of his choosing or choose to pick up the order 130. If delivery is chosen, the server 110 automatically confirms that the address chosen is inside the delivery zone for the restaurant. In some embodiments, delivery distance can be a useful search criterion to cut off the process before ever reaching the delivery selection screen. If the address is outside of the delivery zone, the system 100 can ask the coordinator 102 to choose pickup or to select a different address. Once a delivery address is used, it is then saved in the system 100 for quick selection in the future. The group profile 142 and coordinator profile 148 can reflect that past use of the particular restaurant and the particular delivery selection.

G. Order Scheduling Screen

FIG. 22 is a screen print illustrating an example of an order scheduling screen in a coordinator interface 108.

At this screen the coordinator 102 chooses two separate times and dates. The first time and date specifies the deadline Invitees have to place their order. Once this deadline 144 passes, the order 130 is automatically sent to the restaurant via fax, e-mail or through a point of sale application. If the order 130 is below a minimum delivery amount, it will notify the restaurant that the order 130 was scheduled for delivery but did not meet the minimum. In such a circumstance, the coordinator 102 will also be notified that the order is below the minimum, and will be requested to contact the restaurant to make special arrangements. In other embodiments, the system 100 is configured to notify the coordinator 102 of the order 130 regardless of whether or not there is a problem with the order 130. Some embodiments of the system 100 require the coordinator 102 to approve the order 130 before it is sent, while in other embodiments, the order can be automatically approved.

H. Select Payment Type Screen

FIG. 23 is a screen print illustrating an example of a select payment screen in a coordinator interface 108. At this screen the coordinator 102 can select the payment type for the order 130. In some embodiments, payment can be made using electronic means on the same screen. In still other embodiments, invitees 126 can be billed using an account included in the corresponding member profile 138.

I. Send Invitation Screen

FIG. 24 is a screen print illustrating an example of a send invitation screen in a coordinator interface 108.

At this screen the coordinator 102 specifies a message to the group 116, including instructions for collecting money, and a phone number in case the restaurant needs to be contacted.

J. Preview invitation Screen

FIG. 25 is a screen print illustrating an example of an invitation preview screen in a coordinator interface 108.

If the coordinator 102 chooses to preview the invitation 124 before sending it to the various invitees 126, the “Preview Invitation” button can be clicked to preview the invitation 124.

K. Order Confirmation Screen

FIG. 26 is a screen print illustrating an example of an order confirmation screen in a coordinator interface 108.

At this screen, the coordinator 102 is given confirmation that his invitation 124 has been successfully sent and is given a link to place his own portion of the order 130 because in the example, the coordinator 102 is also an invitee 126. The coordinator 124 need not always been an invitee 126.

VII. Alternative Embodiments

In accordance with the provisions of the patent statutes, the principles and modes of operation of this invention have been explained and illustrated in preferred embodiments. However, it must be understood that this invention may be practiced otherwise than is specifically explained and illustrated without departing from its spirit or scope.

1. A method for receiving food orders for a group, comprising:
accepting a vendor selection for a group;
sending a communication to at least one invitee associated with the group not responsible for the vendor selection; and
receiving a menu selection from at least one invitee not responsible for the vendor selection.

2. The method of claim 1, further comprising providing a vendor list in response to a search criterion.

3. The method of claim 1, further comprising creating the group and a membership list for the group.

4. The method of claim 1, wherein a plurality of members can be added to the group with a single interface interaction.

5. The method of claim 1, further comprising setting a deadline for joining an order.

6. The method of claim 5, wherein all completed orders are automatically sent to the selected vendor after the deadline.

7. The method of claim 1, further comprising identifying a cost associated with each order.

8. The method of claim 7, further comprising transmitting a bill to each participating invitee.

9. The method of claim 1, further comprising storing multiple groups defined by a single coordinator.

10. The method of claim 1, wherein the vendor selection is influenced by at least one of: (a) a group profile; (b) a coordinator profile; and (c) an invitee profile.

11. The method of claim 1, further comprising providing an address book interface configured to store a plurality of invitee addresses.

12. The method of claim 1, further comprising accepting an electronic payment from the participating invitee.

13. A system for processing group orders, comprising:
a server, said server including an application and a database, said database comprising a plurality of groups and a plurality of potential invitees, wherein at least one said group is associated with at least two said potential invitees;
a coordinator interface, wherein said coordinator interface is configured to create an order, said order includes a plurality of order attributes, said order attributes comprises an invited group, wherein said coordinator interface identifies said invited group from at least one said group stored in said database;
a plurality of invitee interfaces, wherein only said invitee interfaces associated with said invited group receive an invitation, and wherein said invitee interfaces are configured to transmit a plurality of responses to said invitation;
wherein said application generates said invitation using said order;
wherein said coordinator interface provides for creating, modifying, and deleting at least one said group; and
wherein said coordinator interface provides for creating, modifying, and deleting at least one said invitee stored in said database.

14. The system of claim 13, wherein said order is a meal, and wherein said selection in response to said invitation is a menu selection.

15. The system of claim 13, further comprising an ASP and a plurality of vendors, wherein said order includes a vendor selected from a plurality of available vendors, and wherein each said vendor pay a transaction-based charge to said ASP for inclusion in said database.

16. The system of claim 13, wherein said invitation includes a message created with said coordinator interface.

17. The system of claim 13, wherein said invitation is associated with a deadline.

18. The system of claim 13, wherein said invitation is an e-mail providing for at least 3 predefined possible responses.

19. The system of claim 13, wherein said invitee interface records said invitation on a calendar accessible on a computer from which the invitee interface is accessed.

20. A system of processing group interactions, comprising:
a membership subsystem, including a group and a plurality of members, wherein said group includes at least one said member;
a vendor subsystem, including a plurality of vendors and a plurality of vendor locations, wherein each said vendor is associated with at least one said vendor location; and
an order subsystem, including an order, a plurality of order attributes, and a plurality of invitations, wherein said order subsystem provides for associating said order with said order attributes, wherein said order attributes includes said group and said vendor, wherein said invitations are automatically sent to said members associated with said group that is associated with said order, and wherein said order subsystem provides for receiving responses to said invitations relating to said order.

21. The system of claim 20, wherein said event subsystem provides for displaying a subset of available vendors for association with said order, wherein said subset of available vendors are selectively identified in response to a search criterion.

22. The system of claim 20, wherein said membership subsystem includes a plurality of groups, said plurality of groups including a first group and a second group, wherein said first group is defined by said membership subsystem to include said second group.

23. The system of claim 20, wherein said event is a reoccurring event.

24. The system of claim 20, wherein said invitation includes a payment instruction.

25. The system of claim 20, wherein said event subsystem provides for generating an invitation preview.

26. The system of claim 20, wherein said event subsystem automatically generates a plurality of confirmation notices sent to a plurality of participating members.
